(19) United States
(12) Patent Application Publication
(10) Pub. No.: US 2003/0211024 A1
(43) Pub. Date: Nov. 13, 2003

(54) Methods of converting urea to ammonia for SCR, SNCR and flue gas conditioning

(76) Inventor: David Lee Wojichowski, East Hampstead, NH (US)

Correspondence Address: DAVID WOJICHOWSKI, 22 PARTRIDGE LANE, EAST HEMPSTEAD, NH, 03826, US

(21) Appl. No.: 10/361,911

(22) Filed: Feb. 11, 2003

Related U.S. Application Data
(60) Provisional application No. 60/379,193, filed on May 10, 2002.

(51) Int. Cl. C01C 1/08; B01J 19/00

(52) U.S. Cl. 423/235; 423/358; 422/198; 422/187; 422/232

(57) ABSTRACT

This invention relates to pollution control requirements for fossil fuel burning facilities, such as power plants, incinerators and cement kilns, and more particularity, to improved methods of generating ammonia from urea. Ammonia is the critical chemical additive used to reduce the emissions of nitrogen oxides from the combustion effluent by both selective non-catalytic reduction and selective catalytic reduction techniques.

This Application claims the benefit of Provisional Patent Application No. 60/379,193 filing date May 10, 2002. The applicant is unchanged, the title has changed to more accurately reflect the nature of the Inventions.

### CROSS-REFERENCE TO RELATED APPLICATIONS

NONE

### STATEMENT REGARDING FEDERAL SPONSORSHIP

No portion of this invention was made under government sponsored research or development.

### BACKGROUND OF THE INVENTION

Ammonia is classified as a hazardous material and is a highly volatile noxious material with adverse health effects, intolerable at very low concentrations and presenting significant environmental and operational risks. Urea, on the other hand, is a stable non-volatile environmentally benign material that poses no such risk. Under heat, urea breaks down to form ammonia, which can then be used at many industrial plants. This invention describes improved processes of converting urea to ammonia to avoid the risks associated with the transportation, storage, and handling of ammonia.

There are at least two important industrial users for ammonia. Industrial furnaces, incinerators, and electric power generators use ammonia to lower the amount of nitrogen oxides (NOx) discharged to the atmosphere in their combustion gasses. Another important use is for “conditioning” of flue gas for enhanced collection of particulate matter, or fly ash. αβ The production of NOx is an unavoidable consequence of burning fossil and non-fossil fuels and has been targeted by Federal and State regulatory agencies for reduction in order to minimize levels of acid rain and ozone/smog. The method of choice to reduce emissions of NOx is by conversion of NOx into inert nitrogen gas (N2) by reaction with amine-type reductant materials, namely urea and ammonia. The two fundamental processes are Selective Catalytic Reduction (SCR), which requires ammonia, and Selective Non-Catalytic Reduction, which can use either urea or ammonia.

In this invention, urea is converted to ammonia at the site in-situ or immediately prior to the point-of-application to eliminate the need to store and transport ammonia. In this way, urea is the material that is shipped, stored, and handled on-site. For maximum commercial application, the processes to convert urea to ammonia should be simple and cost-effective. This Application fills that need in the marketplace.

The basic chemistry employed in the hydrolysis of urea is the reverse of the method by which urea is produced from ammonia and carbon dioxide and involves two basic steps. The first reaction is the combination of water with urea to form an intermediate carbamate. The second step is the thermal breakdown of the intermediate to ammonia and carbon dioxide. The first step is exothermic and very quick. The second is endothermic and is overall rate limiting, commencing at around 230 degrees F. and becoming rapid at around 300 degrees F. As in any chemical process, the reaction is not perfect. In this case, the second step involves the formation of free-radicals which can recombine to form compounds which are less prone to break down into their ultimate thermal products. Some of these compounds are biuret, triuret, cyanuric acid, monomethlolurea, dimethylolurea, and melamine. The optimization of this second step requires the economic application of high energy in the form of temperature.

There is substantial prior art relating to hydrolysis of urea to ammonia. The earliest of these has urea in dilute wastewater streams converted to ammonia for internal recycle back into the urea manufacturing process. This has been disclosed in U.S. Pat. No. 3,826,815, U.S. Pat. No. 3,922,222, U.S. Pat. No. 4,087,513 and U.S. Pat. No. 4,168,299. None disclose the use of urea as a source of ammonia for other uses. In particular, there is no visualization of feeding urea to a hydrolysis reactor to specifically produce ammonia for use in gas conditioning, SCR and SNCR systems, or to avoid the hazards of shipping, storage, and handling ammonia.

More recently, there has been substantial activity in the patent literature to disclose a system for the controlled hydrolytic decomposition of urea to produce ammonia. Von Harp, et al in U.S. Pat. No. 5,240,688 discloses an in-line process for hydrolysis of urea for use in an SNCR system. The process requires the heating of the reactants in a liquid state and held at high temperatures for at least three minutes. The primary motive claimed for this invention was the decreased production of nitrous oxide, which is a side reaction of urea based SNCR chemistry.

Jones, in U.S. Pat. Nos. 5,281,403 and 5,827,490 has claims very similar to von Harpe. A urea solution is heated in an injection lance or other piece of equipment while keeping the urea hydrolysis products in the liquid phase. In all claims, Jones requires the use of a hydrolysis catalyst to speed the reaction rate of breaking urea down to ammonia.

Laguna, in U.S. Pat. Nos. 5,985,224 and 6,093,380 disclose processes wherein ammonia is stripped from a heated urea solution by means of sparging steam through the liquid inside a pressure vessel, or flashing the heated liquid to a lower pressure. The stripped hydrolysis solution is recycled back to another process for use in dissolving additional urea.

Cooper, in U.S. Pat. No. 6.077,491 and pending US application No. 20020102197 discloses a process very similar to Laguna in '224 and '380. A large quantity of urea liquid is heated in a pressure vessel to force the hydrolysis reaction and drive off ammonia gas. The essential difference with this disclosure is that the stripped, low urea concentration, hydrolysis solution is retained in the pressure vessel and completely evaporated along with the ammonia product.

As of the date of this application, the Laguna and Cooper technologies are the only two which are operational in industrial facilities. These facilities produce ammonia from urea for use at SCR facilities. There now appears to be fundamental flaws in these technologies which the present invention resolves. One problem is corrosion. Even with moderately high alloy stainless steels, the vapor phase product from these reactors is causing metal loss and fluid discoloration.

The other problem is the creation and accumulation of high molecular weight reaction byproducts. These compounds accumulate in the liquid phase of the reactor and are not destroyed at their respective operating temperatures.

Peter-Hoblyn, in U.S. Pat. No. 6,203,770 discloses an apparatus which heats a urea solution by way of a “pyrolysis” chamber constructed of heated internal surfaces. While there is some debate whether the process is pyrolytic or hydrolytic, the intent of the apparatus is for use on internal combustion engines, especially in mobile applications. All claims require the application of solution recirculation lines for returning solution not sprayed into the indirectly heated chamber. The improvement in this Application is a simplification of this disclosure which results in lower cost of equipment and lower costs to operate and maintain.

Arrand, in expired U.S. Pat. No. 4,208,386 discloses that solid phase urea can be injected into a hot combustion gas stream in a pulverized form, not as a liquid, to achieve equivalent SNCR performance to that obtained by a urea solution. Once subjected to the hot gas temperature, the solid phase urea breaks down into ammonia (and other byproducts) allowing the SNCR reaction to occur. The professed advantage of this disclosure is primarily in material handling—ease of handling, storage, and introduction. The improvement in this Application simplifies the equipment requirements, thereby decreasing the cost of the technology and improving its commercial potential. Further, this Application teaches the use of commercially available solid urea in certain types of combustors, without the need to pre-process the chemical in any way prior to introduction.

VonHarpe, in U.S. Pat. No. 5,728,357, discloses a process by which dry urea prills can be pneumatically injected at high velocities into the open end of a rotary cement kiln. In this way, the urea is propelled past a temperature zone unfavorable to the SNCR reaction into a zone which is more favorable. The improvement in this Application is the disclosure of alternate forms of solid urea and alternate methods of introduction, both of which represent improvements in reliability and/or economics.

Hoffman, in US Patent Application No 20,010,016,183, discloses a process by which urea solution is converted to ammonia by irradiation with microwaves in the presence of a catalytic converter. The likelihood of catalyst fouling has limited the commercial success of this technique. This Application involves the elimination of the catalytic converter and the application of higher dosage of microwave energy.

The art is awaiting the development of a processes and apparatus that would permit the use of urea in SNCR and SCR processes in a simpler, more reliable, more economic, and safer manner. This Application is intended to provide that technology.

### BRIEF SUMMARY OF THE INVENTION

The object of the present invention is to provide economical methods of converting urea to ammonia in a more cost effective manner, without the deficiencies and disadvantages of the prior art devices and methods. Ammonia is required to reduce nitrogen oxide emissions in SNCR (Selective Non Catalytic Reduction) and SCR (Selective Catalytic Reduction) processes.

The invention relates to improved methods to convert urea to ammonia. In most cases, the existing methods are improved by increasing the speed of the reaction. This has an advantage of requiring less equipment and allowing faster process response time. In other cases, the improvement involves a simplification of an existing process. These improvements can be applied in virtually any combustion effluent gas for economical reduction of nitrogen oxides. Those applications are boilers, combustors, combustion turbines, piston-engines, flares, process heaters and the like.

### BRIEF DESCRIPTION OF THE DRAWINGS

FIG. 1 Direct Contact Steam Heated Reactor with PreHeater

This Figure is a process flow diagram of the preferred embodiment of converting a urea solution into a gaseous ammonia product in an external reactor heated by steam. Steam is direct blended with the solution in a controlled manner and at high temperatures to heat, react, and vaporize the solution in its entirety.

FIG. 2 Direct Contact Steam Heated Reactor in a Vessel Slip Stream

This Figure is a process flow diagram of the preferred embodiment of breaking down urea and urea hydrolysis polymerization byproducts into a gaseous ammonia product in a slip stream around a urea hydrolysis reactor.

FIG. 3 InSitu Fluid Bed Combustor Reactor

This Figure is a process flow diagram of the preferred embodiment of converting solid phase urea directly into a gaseous ammonia product in a fluid bed combustor.

FIG. 4 InSitu Rotary Cement Kiln Reactor

This Figure is a process flow diagram of two embodiments of converting solid phase urea directly into a gaseous ammonia product inside a rotary cement kiln.

FIG. 5 Indirect Contact Electric Heated Reactor in a Vessel Slip Stream

This Figure is a process flow diagram of the preferred embodiment of breaking down urea and urea hydrolysis polymerization byproducts into a gaseous ammonia product in a slip stream around a urea hydrolysis reactor. In this case the source of heat is indirectly supplied in the form of electric heating coils.

### DETAILED DESCRIPTION OF THE INVENTION

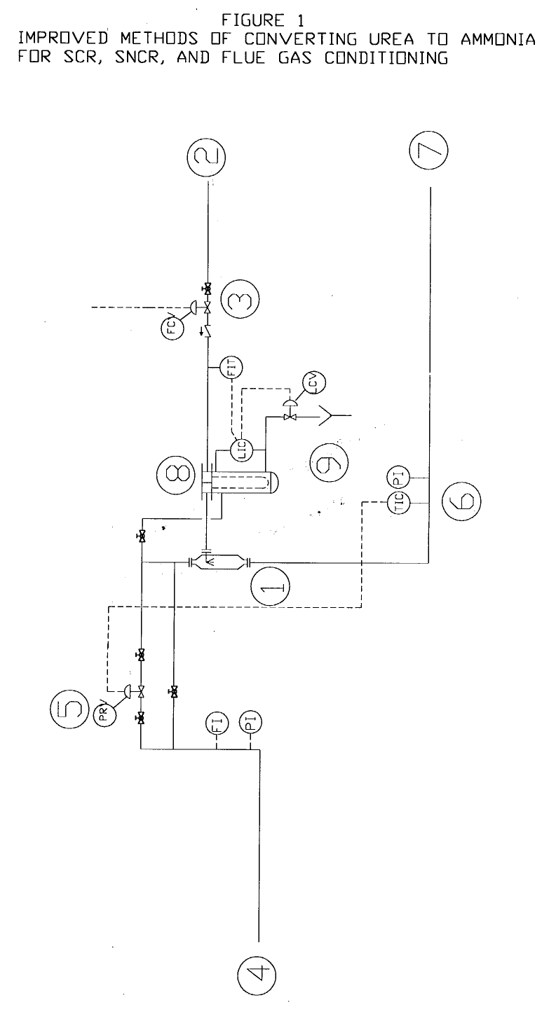

FIG. 1 illustrates one version of the hydrolysis process and the arrangement of its components by which a urea free ammonia gas stream is produced from urea solution. In this version, a urea solution, stream 2, is introduced into the direct contact heat exchanger, item 1, by way of a control valve, item 3. Steam, slightly superheated in form, noted as stream 4, is introduced into the the heat exchanger 1, by way of a control valve, item 5. The proportion of steam is controlled to maintain the outlet temperature from item 1 by way of measuring downstream temperature at item 6. The temperature setpoint of item 6 is selected to ensure that sufficient energy is directly applied to the solution to effect complete reaction and evaporation of the solution to its gaseous product, stream 7. To improve thermal efficiency, a solution preheater, item 8, is included to provide sensible heat, partial reaction, and partial evaporation of the incoming urea solution. The net effect of preheating is to reduce the overall quantity of steam needed to conduct the operation. For simplicity, the steam provided to the preheater comes from the same source as that to the direct contact heat exchanger. The preheater condenses the steam, which is then returned to the main plant process in the form of condensate, stream 9.

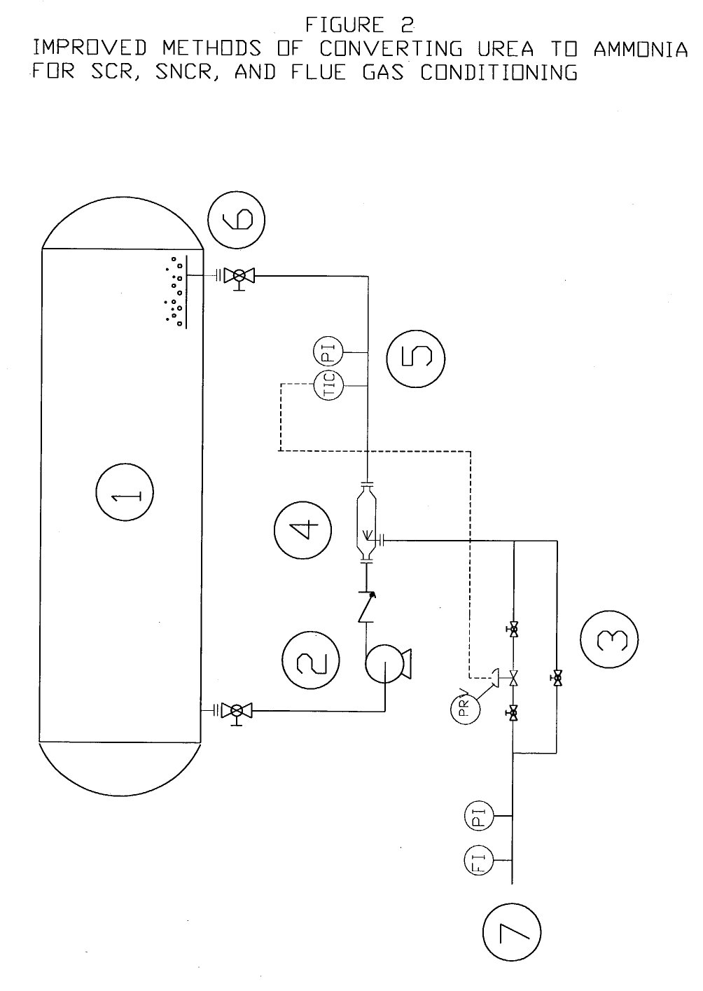

FIG. 2 illustrates another version of the hydrolysis process and the arrangement of its components by which urea and urea hydrolysis polymerization byproducts are broken down to ammonia as installed as a slip stream on a urea hydrolysis reactor. In this version, the urea hydrolysis reactor, item 1, is operated at a pressure and temperature insufficient to destroy the polymerization byproducts of the hydrolysis reaction. A quantity of solution is drawn in a controlled manner from the reactor by a pump, item 2, mixed with high temperature steam in a mixing tee, item 4, and the combined stream reintroduced to the reactor by sparging (item 6) the gas into the reactor's liquid. Sufficient steam, item 7, is added via the control valve station, item 3, to maintain a preset temperature as measured at item 5. Sufficient steam at a sufficient temperature is applied to the liquid to completely react the urea and urea byproducts to ammonia gas as well as evaporate the excess water to steam.

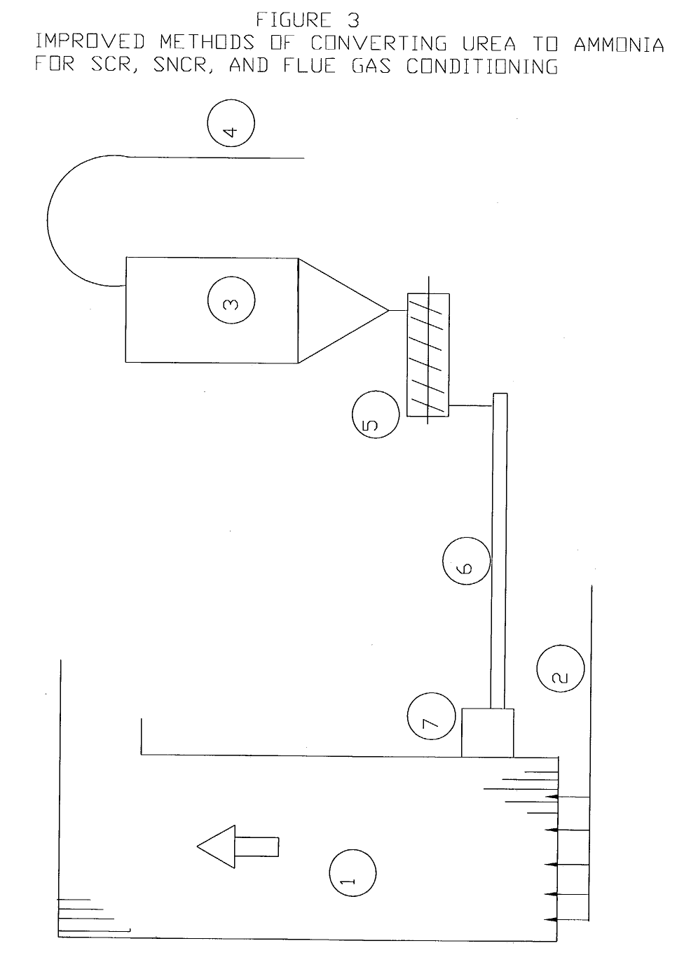

FIG. 3 illustrates one version of the pyrolysis process and the arrangement of its components by which a solid urea is converted to gaseous ammonia inside a fluid bed combustor, item 1. In this version, the solid urea is conveyed in stream 4 to a bulk storage device, item 3, for intermediate storage. Unprocessed solid urea flows out the bottom of the bin to a motorized feeding device, item 5, which controls the feed rate of the solid urea out of the bulk storage device. From the discharge of the feeding device, the material is fed via a conveying device, item 6, to the interface, item 7, with the combustor. The conveying device can be any number of mechanisms such as a gravity chute, mechanical screw conveyor, or pneumatic conveyor. Likewise, the interface with the combustor can be located at any convenient point of the combustor such as the fuel feeders, limestone feeders, ash recirculation system, or bed ash coolers. The combustion air flow, stream 2, entering underneath the combustor provides a highly turbulent environment which suspends the solid urea into the hot combustion plasma where it breaks down by pyrolytic and hydrolytic processes to gaseous ammonia.

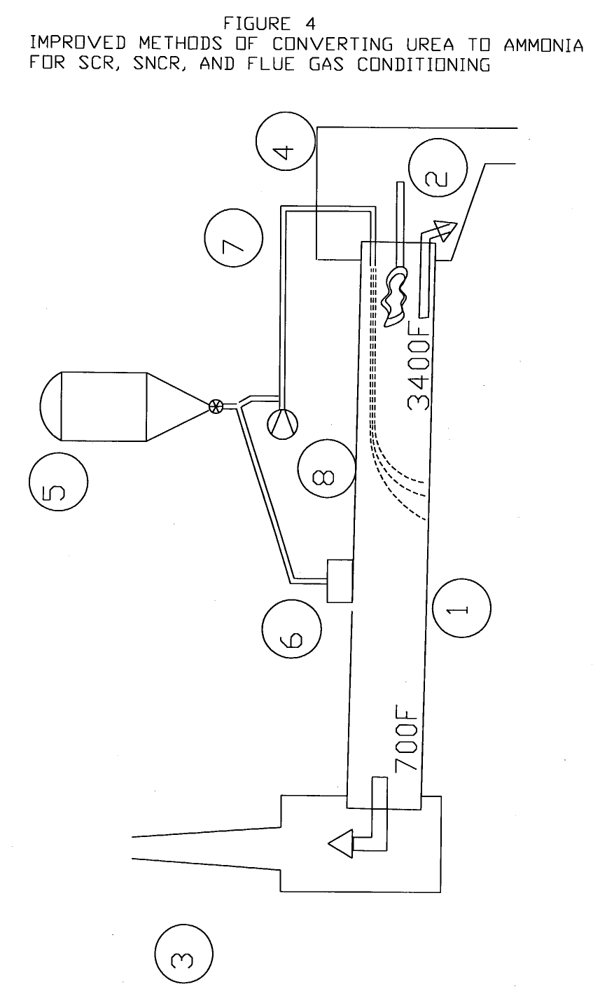

FIG. 4 is a cross sectional sketch of a typical long tube rotary cement kiln, item 1. The kiln is very long (often 300 meters), rotates slowly, and is very slightly inclined downward from raw material inlet to product outlet. Hot gasses flow countercurrent in relation to the solids, with heat provided by a fuel burner, item 2. At burner end, the temperature is typically 3400F, travels down the barrel of the kiln cooling to approximately 700F upon exit where it is filtered and exhausted at the stack, item 3. The cement clinker is cooled and removed from the hot end of the kiln, item 4. There is little opportunity to introduce ammonia or urea to the solid cylindrical walls of the kiln. Reagent introduced at the cold end of the kiln will be unreacted, stripped off by the 700 degree temperature, and exhausted out the stack. Reagent introduced at the hot end will oxidize to form additional nitrogen oxides. Solid urea stored in a bin, item 5, is introduced mid-point to the kiln in either of two ways. Often, the kilns have mid-point openings, item 6, located at radial points used for supplemental fuels such as rubber tires or solid hazardous wastes. Solid urea in prill, granular, or conglomerated form, introduced into these ports on a semi-batch basis would heat, decompose into ammonia, and react in accordance with the SNCR process. Alternatively, granular urea can be propelled in an air powered conveyor, item 7, at high velocity through either open end of the kiln to reach and settle into a mid point of the kiln. At the point the temperature would be more suitable for SNCR that either extreme. The granular urea is entrained in air produced by the air compressor, item 8, which provides the velocity and energy needed to propel the urea to the proper temperature regime.

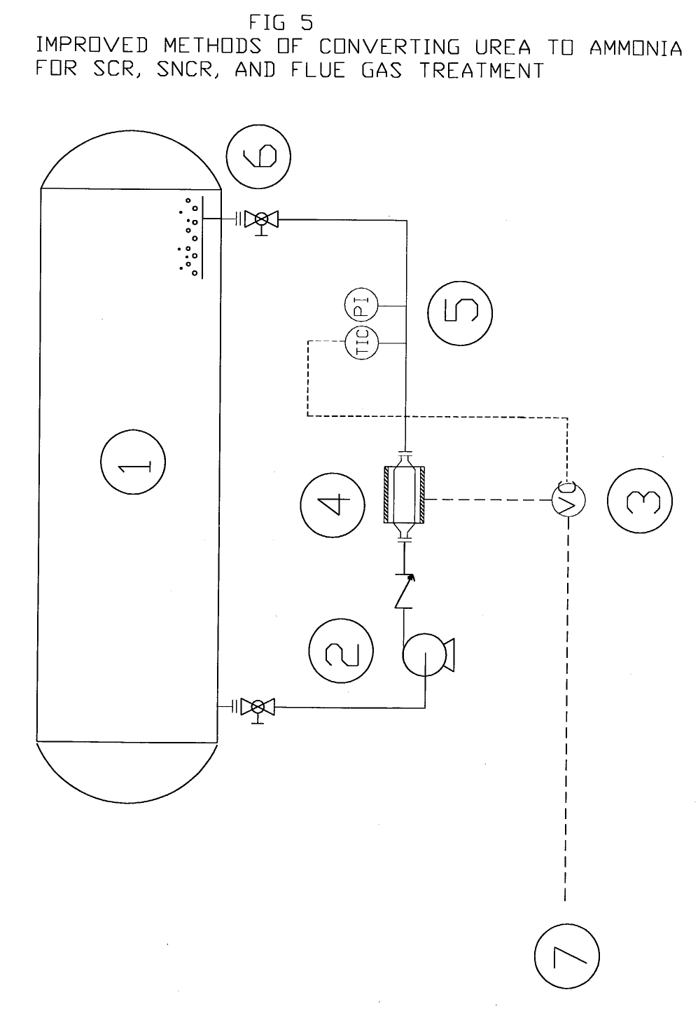

FIG. 5 is a flow diagram, similar to FIG. 2, except that the energy to break down the urea and urea hydrolysis polymerization byproducts is provided by an indirect electric heater, item 4. Temperature feedback from the downstream location, point 5, controls the amount of energy to the heater. The reacted product is introduced back to the reactor vessel, item 1, below the liquid line by sparging, item 6, to conserve energy.

### DESCRIPTION OF THE IMPROVEMENTS

The dissociation of urea into two moles of ammonia and one mole of carbon dioxide is well known, whose the primary hydrolysis reaction proceeds in two steps as follows:

Step 1: Urea plus water yields ammonium carbamate

H2N—CO—NH2+H₂O═H2N—CO2+NH4

Step 2: Ammonium carbamate plus heat yields ammonia plus carbon dioxide

H2N—CO2+NH4+HEAT=2×NH3+CO2

The first step is slightly exothermic and proceeds very quickly. The second step is endothermic and is rate limiting to the overall reaction. To optimize the urea to ammonia process, the focus must be on the second step. This invention accomplishes this task by using higher temperatures and more direct contact with the heating medium. This process is especially favored in acidic solutions.

In more alkaline solutions, alternate reaction pathways can become significant. This is important since the evolution of ammonia pushes the hydration solution basic (pH 9-10). In these pathways, at sufficient temperature, urea can break down directly to iso-cyanic acid (ICA) according to the following formula:

H2N—CO—NH2+HEAT=NH3+HNCO

Then, ICA can then combine with another molecule of urea to form biuret according to the following formula:

HNCO+H2N—CO—NH2=H2N—CO—NH—CO—NH2

Further, biuret can combine again with urea to form triuret, or with more ICA to form cyanuric ammonia acid, ammelide, cyanuric acid, ammeline, melamine, and other larger molecular weight nitrogen based organic compounds.

As well, urea in an alkaline solution can combine with formaldehyde to form monomethylolurea and dimethylolurea. Formaldehyde in a commonly applied conditioning agent on solid urea.

It is well known that urea solution, when injected into a combustor's high temperature (1300-2000 degrees F.) regime rapidly breaks down into ammonia and carbon dioxide. This is the essential process described by Arrand in U.S. Pat. No. 4,208,386. In that disclosure, Arrand suggests a necessary residence time of as low as 0.001 seconds to both convert urea to ammonia and to react ammonia with NOx in accordance with the SNCR process. In practice, it has been demonstrated in commercial applications that approximately 0.1 seconds of residence time is needed. This is much less that that required by Von Harp, Laguna, and Cooper—who all suggest several minutes to complete the reaction in a liquid phase. Likewise, the improvements do not require the use of hydrolysis catalysts such as described by Jones to speed the reaction.

One of the improvements embodied in this invention is to dramatically decrease the residence time needed for complete reaction, approaching that noted for direct furnace injection SNCR. The essence of the improvement is to atomize the solution into a hot gas stream. Steam would be most optimum, since it would saturate the shrinking droplets in an environment of the water needed to ensure hydrolysis. Hot air can also be used and has an advantage in that it reduces condensation downstream of the atomization point—which is a valuable consideration for practical industrial applications. Therefore, prior to the point of introduction to the combustion gas upstream of the SCR catalyst, aqueous urea solution is finely atomized into a stream of hot air or steam. The heat of the hot fluid is transferred to the droplet, initially increasing its temperature up to the boiling point and driving off excess water. The droplet dries to primarily ammonium compounds which then, subjected to the very high temperature of the heating fluid, breaks down to its ultimate reaction products of ammonia and carbon dioxide/monoxide. The reaction is extremely rapid, which would lead to very compact and cost effective equipment. Enough hot medium is provided to control the final outlet temperature to that which is desired to complete the evaporation and reaction. In the case of steam, the outlet temperature would be controlled to ensure that the fluid temperature is still higher that its saturation temperature.

The advantage of this arrangement is obvious with a little knowledge of the reaction chemistry. The urea hydrolysis polymerization byproducts (biuret, triuret, cyanuric acid, ammonium isocyanate, monomethylolurea, dimethylolurea, melamine, cyanamide, etc.) require higher temperatures to break back down to ammonia that urea alone. The processes envisioned by Laguna and Cooper are very inflexible to the application of higher temperatures—providing only the temperature necessary for the primary decomposition pathway. The commercial installations of these technologies show an accumulation of these higher molecular weight compounds in their reactors—which cannot escape at the operating temperatures used. This Invention allows very flexible application of the higher temperatures needed to break these byproducts down to their ultimate ammonia forms.

A student knowledgeable in the art will recognize the flexibility of this invention in applying very high temperatures, but also recognize the weakness of the invention in terms of thermal efficiency. For this reason, the skilled practitioner will recognize the advantage in pre-heating the solution prior to contact with the heating medium. In the case of steam, preheating will allow the utilization of the latent heat of vaporization in the pre-heating process, allowing a substantial decrease in steam consumption. The same general conclusion applies for the use of hot air. With pre-heating, the majority of the energy applied to the process can be for pre-heating and initial reaction, leaving the last step with enough flexibility to economically raise the process temperature as high as necessary.

Therefore, one facet of this invention is to develop a method which most simply decomposes urea and urea polymerization by products into ammonia by direct blending with steam or hot air. The energy in the hot medium evaporates and causes the reaction on a near instantaneous basis, as well as allows the application of high temperatures to break down products of side reactions. No catalyst is needed. The output of this apparatus can be used in either SNCR, SCR, or flue gas conditioning processes. Pre-heating the solution would provide great operational cost savings and make the process very competitive with all known alternatives.

For existing urea hydrolysis reactor vessels which are having operational problems due to the accumulation of urea hydrolysis polymerization byproducts, this invention allows a very cost effective solution. A very small slip stream of liquid is withdrawn from the reactor vessel by controlled pumping, direct blended with high temperature steam or air, and reintroduced back to the vessel below the liquid level. In this way, the large organic nitrogen molecules are destroyed and the energy used is conserved in the process. The reactor can continue to operate at the same temperature and pressure. This technique merely provides a localized high temperature point in the system to maintain low concentrations of the polymerization byproducts.

Another facet of this invention is an improvement to the Peter-Hoblyn patent and Hofman application. The application of very high temperatures to a urea solution can also be readily accomplished by indirect means. By indirect, it is meant that a heat exchange chamber is constructed with heated surfaces upon which the urea solution is applied. The heat breaks down the urea in the same way as the direct methods described above. In the case of the Peter-Hoblyn patent, the application can be applied in large stationery combustion sources and can be implemented without the additional expense of solution recirculation lines by sound engineering of the hydraulic equipment. The technique would be especially efficient with the use of heat in the form of electricity, said heat transferred through the chamber walls by conduction to contact the urea solution. Another innovative method would be the use of microwave energy, transferred through an appropriate material, which is then readily absorbed into the aqueous solution. If sufficient microwave energy is used, a hydrolysis catalyst would be unnecessary and inadvisable.

A fluid bed combustor is a common combustion unit used to process low grade fuels such as waste wood, waste coal, petroleum coke, and low quality virgin coals. Because of their unique design, they have combustion temperatures much lower than that used in high quality fossil fuels. In addition, they are much more amenable to the introduction of fuels and chemicals as a larger diameter solid. Typically, SNCR of these units is conducted in the traditional manner, with urea or ammonia injected into the combustion effluent in a liquid or gaseous state. The Arrand patent disclosed the efficacy of the use of dry urea, in a pulverized form, to effect the SNCR reaction. This disclosure has had limited or no commercial application due to the difficulty and cost in producing the pulverized material and adequately injecting the powder into the correct temperature regime. The use of liquid urea reagents was always the preferred embodiment. This is not necessarily correct for fluid bed combustors. In fact, the opposite appears to be true. Unlike other boilers and incinerators, there is no location within a fluid bed unit where the gas temperature is high enough to oxidize the ammonia created from urea into additional nitrogen oxides. Therefore, the urea can be introduced into the system in the most convenient location without concern for the counterproductive oxidation reaction. That location happens to be near the bottom of the combustor, where fuel and recycle ash is introduced. Since these are solid materials, another solid chemical can readily be added at very low capital cost. The very high vertical gas velocity in the combustor suspends (i.e., fluidizes) the solid materials in a plasma of low temperature (i.e., 1600-1700 degF) burning materials. Solid urea introduced to the combustor would fluidize as well and quickly breakdown into ammonia. The first key advantage to doing this would be the ability to use commercial solid ureas, prill and granular, without the need to pulverize the chemical. In fact, an excellent argument can be made that introducing pulverized urea at this location would be less optimum than the commercial sizes since the pulverized variety would easily be fluidized—breaking down into ammonia at a higher elevation thereby reducing the mixing and residence time so essential to the SNCR process. The fluid bed combustor can easily handle urea granules as large as 5 mm—which is the approximate upper size range of granular urea. Also, granular urea is the easiest solid form of urea to store and process—being commonly done at thousands of small farms wordwide. The second key advantage is SNCR performance. Commonly, urea or ammonia solution is introduced at the top of the combustor just prior to hot cyclones. At this point the residence time at proper temperatures for the SNCR process is short. The result is the need to apply excess reagent to accomplish the same level of performance. Excess reagent is costly and is reflective of the potential of passing unreacted ammonia gas through the boiler heat transfer tubes—which can cause corrosion and/or surface heat transfer fouling. Urea applied at the bottom of the combustor has far greater residence time to perform the SNCR reaction—which will be reflective of higher nitrogen oxide reduction at a lower reagent consumption and lower ammonia slip.

The last broad area Improved Methods is targeted toward SNCR processes at rotary cement kilns. Cement kilns are large consumers of energy, which is the key component needed to convert limestone, shale, silica, and iron ore into cement. The high combustion temperatures create significant emissions of nitrogen oxides. The application of SNCR to cement kilns is problematic due to the nature of the kiln itself—essentially a rotating barrel open only on either end. Futher, the gas temperatures and the direction of gas and clinker flows at either end are not conducive to spraying liquid urea—one end is too hot, resulting in the oxidation of the urea/ammonia into additional nitrogen oxides—the other end too cold to effect the reaction. The vonharpe '357 patent describes a method by which prill urea is pneumatically injected into the cold end of the kiln with sufficient velocity to propel the urea to a point of more advantageous temperature. Granular urea, on the other hand, would be a more advantageous choice of solid urea since it has a larger mean diameter, which would improve the projectile characteristics and throw distance of the solid urea into the cement kiln. In addition, granular urea is more readily available as a commercial commodity and is easier to store and handle than prill urea. Granular urea and prill urea are made in very different processes and have quite different purities and cost. This technique would also be useful in certain long barrel waste fuel incinerators.

Aside from the open ends of the rotary kiln, there is often an opportunity to introduce solid urea into the mid-point of the kiln using special material feeders which have been installed to feed rubber tires and/or solid hazardous/special wastes. Depending upon the diameter of the kiln, one or several material feeders can be installed along the circumference of the kiln. As the kiln slowly rotates, the solid fuel is added to the special feeder chamber. Double doors act as an airlock on the feed chamber such that when the feeder reaches the top point of the arc, the material is dropped into the kiln without drawing excess air to the kiln. The gas temperature at this point is appropriate for the SNCR process. These feeder can be successfully used to feed either granular or prill urea. However, since the feed process is batch, additional consideration might be given to modifying the character of the solid chemical to release more slowly. In this way, the solid urea will time release ammonia to an elapsed time needed until the next feeder releases urea to the kiln. This time release function can be provided in a number of ways, the most likely being the consolidation of granular urea into briquettes. The larger size will cause a longer time needed for break-down of the urea to ammonia. The net effect on the SNCR process would be a more consistent release of ammonia and a more consistent nitrogen oxide removal.

What is claimed is:

1. A process for converting an aqueous solution of urea, possibly including urea hydrolysis polymerization byproducts such as biuret, triuret, monomethylolurea, dimethylolurea, ammonium carbamate, cyanuric acid, isocyanic acid, ammelide, ammeline, and melamine, to ammonia. The process comprising:
a. Heating the incoming fluid to a temperature greater than 300 degrees F.;
b. The heating medium is steam or hot air, in direct contact with the urea solution by blending together in a mixing apparatus;
c. The mixing apparatus is a once-through device, with no liquid phase retention, and no liquid phase recirculation.

2. A process according to claim 1 wherein the output of the mixing apparatus is not completely converted, but introduced to an additional heating process downstream for completion of the reaction and vaporization.

3. A process according to claim 1 wherein the feed to the mixing apparatus has been pre-heated to a temperature above 200 degrees F. and may be partially reacted and evaporated prior to direct mixing with the steam or hot air.

4. A process according to claim 1 wherein the output of the mixing apparatus is injected into a hot combustion effluent prior to an SCR catalyst. Sufficient steam is supplied to finely atomize the urea solution as well as intimately disperse and mix the droplets into the combustion effluent in such a way to minimize the residence time needed to complete the hydrolysis reaction and evaporation of the excess water.

5. A process according to claim 1 wherein the output of the mixing apparatus is injected into a hot combustion effluent for application in the SNCR process. Sufficient steam is supplied to finely atomize the urea solution as well as intimately disperse and mix the droplets into the combustion effluent.

6. A process for converting an aqueous solution of urea, possibly including urea hydrolysis polymerization byproducts such as biuret, triuret, monomethylolurea, dimethylolurea, ammonium carbamate, cyanuric acid, isocyanic acid, ammelide, ammeline, and melamine, to ammonia. The process comprising:
a. An indirect heat exchange chamber for hydrating a liquid urea solution, which includes heated internal and/or external surfaces, which generates gases from the hydrolysis of urea and vaporization of water, said gaseous discharge leading to an SCR catalyst or to the treatment zone of the SNCR process.
b. Spray means capable of spraying the urea solution into the hydrolysis chamber, comprising of a spray nozzle and it's associated feed line and pumps.
c. The pump and feed line is located close enough to the injection nozzle to eliminate the need of recirculating urea solution from the injection nozzle back to a prior point in the process.

7. A process according to claim 6 wherein the output of the heat exchange chamber is not completely reacted to ammonia and whose water is not completely evaporated, but introduced to a downstream process for completion of the hyrolysis reaction and evaporation of water prior to discharge to an SCR catalyst or to discharge to an SNCR treatment zone.

8. A process according to claim 6 wherein the indirect form of heat is provided in the form of electricity.

9. A process according to claim 6 wherein the indirect form of heat is provided in the form of microwaves without the use of a catalytic converter.

10. A process and apparatus for converting commercially available solid urea into ammonia in a fluid bed combustor, comprising:
a. a furnace section having a turbulent combustion zone;
b. a bulk storage device for holding said additive;
c. a motorized metering feeder for controlling the flow rate of solid urea additive out of said bulk storage device;
d. a mechanical or pneumatic conveying system attached to said bulk storage device whereby the solid urea additives are conveyed to the turbulent combustion zone.
e. The solid urea additive, once admitted to the turbulent combustion zone decomposes to form ammonia which reduces nitrogen oxides by the SNCR method.

11. A process according to claim 10 wherein the commercially available solid urea is prill urea.

12. A process according to claim 10 wherein the commercially available solid urea is granular urea.

13. A process for reducing nitrogen oxide emissions present in a rotary incinerator or rotary cement kiln containing combustion gases by the SNCR method, comprising:
Injecting granular urea at a velocity of at least 75 feet per second into an open end of the rotary drum to propel said granules through the kiln to a zone within the kiln which has a temperature in the range of 1600 to 2000 degrees F. Said granules then decomposing into ammonia which reduces nitrogen oxides in the combustion gasses by the SNCR process.

14. A process according to claim 13 wherein the flow of air used to propel the granules in adjustable to allow control of the throw distance of the granular urea.

15. A process for reducing nitrogen oxide emissions present in a rotary cement kiln containing combustion gases by the SNCR method, comprising:
Injecting solid urea into a mid-kiln feeder at a point which has a temperature in the range of 1600 to 2000 degrees F. Said granules or prills then decomposing into ammonia which reduces nitrogen oxides in the combustion gasses by the SNCR process.

16. A process according to claim 15 wherein the solid urea is consolidated by thermal or chemical means into larger sized conglomerates. Since some methods of mid-kiln solid introduction is not continuous, said conglomerates will decompose into ammonia products more slowly, effectively providing a more consistent ammonia dosage.

17. A process according to claim 15 wherein the solid urea is in the form of prill urea

18. A process according to claim 15 wherein the solid urea is in the form of granular urea.
